(19) United States
(12) Patent Application Publication
(10) Pub. No.: US 2006/0017948 A1
(43) Pub. Date: Jan. 26, 2006

(54) Open source printer driver

(75) Inventors: Burton L. Levin, Lake Oswego, OR (US); Ronnie Neil Patton, Lake Oswego, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/897,144

(22) Filed: Jul. 22, 2004

(51) Int. Cl. G06F 15/00

(52) U.S. Cl. 358/1.13

(57) ABSTRACT

An open source printer driver and corresponding method are provided. The method comprises: accepting a printer driver customization command; modifying a default printer driver algorithm in response to the customization command; building a print job in a printer-ready format using the modified printer driver algorithm. In one aspect, an addendum file is attached to an electronically formatted document. Then, a user interface (UI) is created for the selection of print options, and auxiliary print options are supplied from the addendum file. The print job is built using the auxiliary print options. Alternately, the auxiliary print options can be used to build a portion of the document, and default print options used to build another portion. In a different aspect, an API is used to accept an executable code plug-in module. Then, the printer driver executable code default module is replaced with the executable code plug-in module.

### BACKGROUND OF THE INVENTION

1. Field of the Invention

This invention generally relates to digital image processing and, more particularly, to a dynamically configurable, open source printer driver and corresponding printer driver method.

2. Description of the Related Art

FIG. 6 is a diagram illustrating a conventional printer driver (prior art). The number of finishing and image processing options available for print jobs has become very large. It is increasingly difficult for a user to locate the variety of options available using a conventional driver graphical user interface (GUI). This problem is exacerbated as new finishing options are constantly being added, but old ones are never removed. Finding a particular option can be awkward and frustrating for the user.

Furthermore, when a user is ready to print, the presentation of the image processing options can be confusing. Typically, these options are simplified and described in indirect terms, such as: color slider bars; media type selection; print intent, i.e., photo or text. Thus, the experienced user may find the presented choices too limiting, while the casual user is too confused to make intelligent choices. Still, the software drivers are constructed with all this baggage, resulting in greater cost and limited value.

Device profiles and threshold arrays are two examples of image processing options. Device profiles are data that define color according to a standard's specification for a specified color space. Using these profiles, color can be translated from an input device to the closest possible approximation of the same color using a specific printer. Alternative device profiles can be integrated with conventional drivers. However, the drivers provide a fixed list of profiles that is not easy to extend. Furthermore, while they can be updated in the field, the device profiles cannot be dynamically altered at document print time. In addition, the profiles normally provided represent an averaging of profiles from samples taken off the manufacturing line. A specific device is rarely profiled for a unique customer device. Also, many factors over time require tuning of a device's profile for the most accurate reproduction of color.

Threshold arrays are data that define how an image is to be processed for acuity. Different threshold arrays are embedded in drivers and accessed depending on user options, such as, intent (photo, normal, etc.). Once the driver is installed, the threshold arrays cannot be dynamically changed.

The actual image and color processing algorithms that use the above-mentioned data cannot be changed without recoding and recompiling into a new driver. Conventionally, the printer driver is unalterable.

It would be advantageous if a printer driver could be made dynamically configurable.

It would be advantageous if print jobs could be prepared with addendum files that permitted the selection of printing options.

It would be advantageous if processing algorithm modules could be loaded in a printer driver to replace default processes.

### SUMMARY OF THE INVENTION

The present invention printer driver permits an application to generate an addendum file containing proprietary image processing algorithms, proprietary color management algorithms, job control commands, and formatting and printing options appropriate for a document. This addendum file is sent to the printer driver along with the document to be printed. Examples of addendum file print options and job control commands include: booklet or pamphlet; margin selections; choice of paper type and media; and, n-up.

In another aspect, the printer driver has a published application programming interface (API) for image processing and color management modules. An application may elect to use the driver default modules, as is conventional, or by interfacing with the API, send its own plug-in modules for color management, image processing, threshold arrays, and/or device profiles. This capability means that the printer driver is an open source print driver that can be dynamically reconfigured with plug-in modules that replace the default modules, on a document-by-document basis, or a page-by-page basis.

Accordingly, an open source printer driver method is provided. The method comprises: accepting a printer driver customization command; modifying a default printer driver algorithm in response to the customization command; building a print job in a printer-ready format using the modified printer driver algorithm.

In one aspect, accepting the printer driver customization command includes accepting an addendum file attached to an electronically formatted document. Then, modifying the printer driver algorithm in response to the customization command includes creating a user interface (UI) for the selection of print options and supplying auxiliary print options from the addendum file. The print job is built using the auxiliary print options. Alternately, the auxiliary print options can be used to build a portion of the document, and default print options used to build another portion of the job.

In a different aspect, accepting the printer driver customization command includes using an API to accept an executable code plug-in module. Then, modifying a printer driver algorithm in response to the customization command includes replacing a printer driver executable code default module with the executable code plug-in module. For example, building a print job in a printer-ready format using the modified printer driver algorithm may include using the executable code plug-in module to analyze document content, and building the print job in response to the analysis of image processing elements such as threshold arrays, device profiles, imaging processing plug-ins, media, inks, fonts, image size, or resolution.

Additional details of the above-described method and an open source printer driver system are provided below.

### BRIEF DESCRIPTION OF THE DRAWINGS

FIG. 1 is a schematic block diagram of the present invention open source printer driver system.

FIG. 2 is a diagram illustrating more specifically a first feature of the present invention printer driver.

FIGS. 3A and 3B are diagrams illustrating more specifically a second feature of the present invention printer driver.

FIG. 4 is a diagram illustrating a page selected plug-in aspect of the printer driver.

FIG. 5 is a flowchart illustrating an open source printer driver method.

FIG. 6 is a diagram illustrating a conventional printer driver (prior art).

### DETAILED DESCRIPTION OF THE PREFERRED EMBODIMENTS

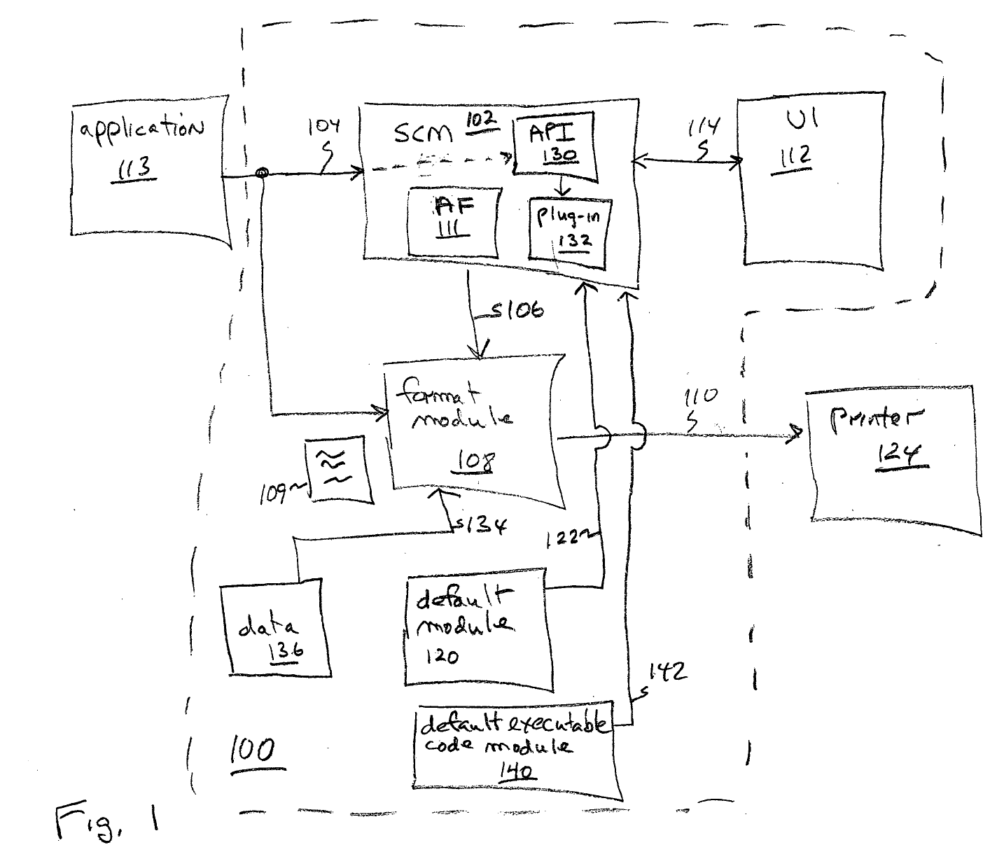

FIG. 1 is a schematic block diagram of the present invention open source printer driver system. The system 100 comprises a source control module (SCM) 102 having an interface on line 104 to accept a printer driver customization command and an interface on line 106 to supply a modified printer driver algorithm in response to the customization command. A format module 108 has an interface on line 106 connected to the source control module, and a printer interface on line 110 supplying a print job in a printer-ready format using the modified printer driver algorithm. For example, the format module 108 can format the print job in a format such as a page description language (PDL) and printer job language (PJL). PS (PostScript) and printer control language (PCL) are examples of PDL. Other examples include PCL5e, PCL5c, PCLXL, and enhanced metafile (EMF). However, this is not an exhaustive list. These languages describe the image and text to be printed.

In one aspect, the system 100 further comprises a user interface (UI) module 112 to supply print options and to accept print option selections on line 114. For example, the UI 112 may be enabled using a monitor and keyboard. The format module 108 has an interface on line 104 to accept an electronically formatted document 109. The electronically formatted document can be supplied from an application 113 such as MSWord, MSExcel, MSPowerPoint, MSPaint, web applications that display on monitors, digital image processing applications such as, Adobe Photoshop, ImageReady, Adobe Illustrator, or FrameMaker. This is not an exhaustive list of every possible application type.

The source control module 102 accepts an addendum file (AF) customization command 111 attached to the document 109, and supplies auxiliary print options to the UI module 112 from the addendum file 111. The addendum file 111 may include auxiliary print options such as booklet, pamphlet, n-up, margin selections, media type, number of copies, output size, or overlay. The above-mentioned list is not intended to cover every possible print option than can be included in an addendum file 111.

The source control module 102 also relays auxiliary print option selections from the UI module 112, to the format module 108. The format module 108 builds the print job using the auxiliary print option selections. Alternately but not shown, the auxiliary print option selections are communicated directly from the UI 112 to the format module 108. In other aspects of the system 100 not shown, the electronically formatted document 109 and the customization command are delivered independently, via different interfaces. For example, the AF 111 can be delivered as a floppy disk

The system 100 typically includes a default module 120 having an interface on line 122 connected to the source control module 102 to supply default print options. In this manner, the UI 112 can supply both default and auxiliary print options. Likewise, the UI 112 can accept default and auxiliary print option selections from a user. The source control module 102 relays selected auxiliary and default print options to the format module 108. The format module 108 builds a first portion of the document, i.e., page 1, using the auxiliary print option selections, and builds a second portion of the document, i.e., page 2, using the default print option selections.

In some aspects, the source control module 102, or some other element of the system 100, deletes the addendum file 111 after the print job is built. In other aspects, the source control module 102 accepts a printer-specific command file with the addendum file 111 and relays the printer-specific command file to the format module 108. The format module 108 sends the print job, with the printer-specific command file, to a printer 124 on line 110. Alternately, the printer-specific command file is sent directly to the printer 124 from the source control module 102.

In another aspect of the system 100, the source control module 102 uses an application programming interface (API) 130 to accept an executable code plug-in module 132 and supplies executable code from the plug-in module 132 to the format module 108. The format module 108 has an interface on line 134 to accept data 136. The format module 108 processes the data 136 using the executable code from the plug-in module 132, and builds the print job using the processed data.

For example, the data 136 can be a device profile, a set of data tables used to convert from one color space to another color space. The device data can be used to convert the colors of an input device, e.g., monitor, scanner, or digital camera, to a device independent color space. The device data can be used to convert the colors of an input device, e.g., monitor, scanner, or digital camera, directly to an output device color space, such as a printer. Further, a device independent color space can be converted to the color space of a specific output device, e.g., a printer or monitor. Thus, neither the image processing, nor the color processing is changed, by changing the profile data. Rather, the actual algorithms of image and color processing may be changed on a job-by-print-job basis and even on a page-by-page basis within the same job.

Alternately, or in addition, the format module 108 uses the executable code from the plug-in module 132 to analyze the content of the electronically formatted document 109, and builds the print job in response to the analysis. For example, the format module 108 analyzes document content such as photo, graphics, or text content. More specifically, the format module 108 analyzes document content and chooses image processing elements such as threshold arrays, device profiles, image processing plug-ins, media, inks, fonts, image size, or resolution, appropriate for printing on the chosen media and inks.

Typically, the system 100 further comprises an executable code default module 140 having an interface on line 142 connected to the source control module 102 to supply default executable code. Then, the format module 108 can build a first portion of the print job using the executable code from the plug-in module 132 to analyze the content of the document first portion, and build a second portion of the print job using the executable code from the default module 140. In one aspect, the source control module 102 erases the executable code plug-in module 132 after the print job is built. Alternately, the executable code plug-in module 132 is established to supply default executable code to the source control module 102. For example, the default executable code module 140 may be erased and replaced by the plug-in module 132. Alternately, the default module 140 is maintained, but assigned a secondary status.

It should be understood that a plug-in module 132 may additionally include the print options associated with the addendum file 111. It should also be understood that several of the above-mentioned interfaces may be the same interface, for example, a shared data/address bus. Further, the above-mentioned elements may be enabled as executable microprocessor instructions stored in a memory.

In some aspects, the application 113 and the printer driver system 100 are embedded in a personal computer. Alternately, the printer driver system 100 can be embedded in a network server, or even within the printer. Further, the interfaces represented by lines 104 and 110 may be local, dedicated connections between devices, or network connections.

### Functional Description

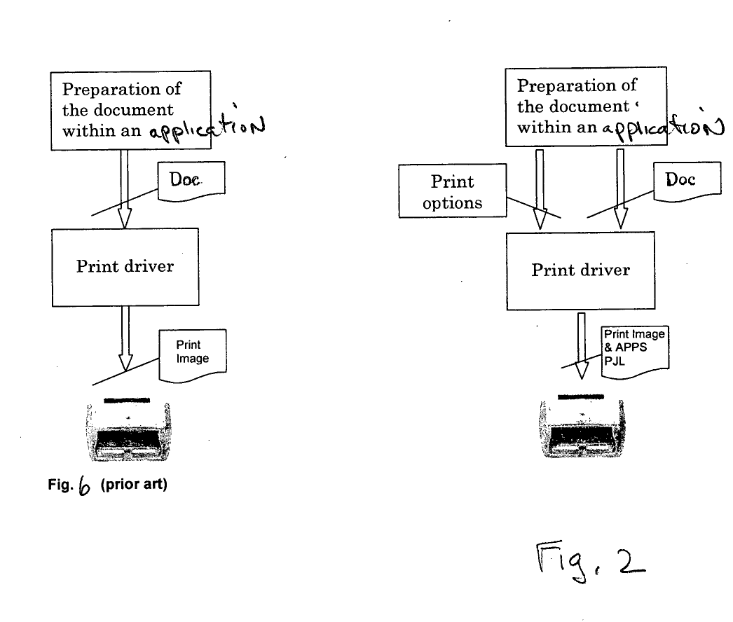

FIG. 2 is a diagram illustrating more specifically a first feature of the present invention printer driver. The printer driver permits an application to generate an addendum file containing formatting and printing options appropriate for the document. This addendum file is then sent to the print driver along with the document to be printed. Examples of print options include: booklet or pamphlet; margin selections; choice of paper type and media; and, n-up. The addendum file need not have all print parameters specified, for example: number of copies to print, or overlay, are print options that need not be included in the addendum file.

The user still has access to the conventional UI, if they want to use it, see FIG. 1. The user then has the option to override the addendum file for any, or all, of the parameters. Generally, the addendum file is generated at the time the document is created, for features that are not available through the conventional UI.

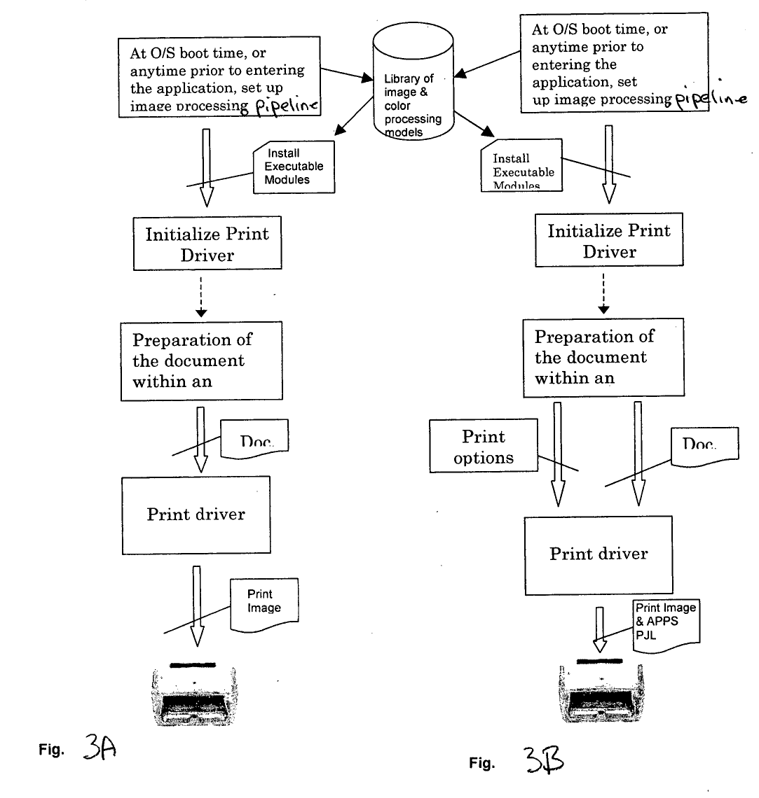

FIGS. 3A and 3B are diagrams illustrating more specifically a second feature of the present invention printer driver. In this aspect, the printer driver has a published API, for downloading image processing and color management modules to the driver. Any application can then use the default modules in the driver or send its own plug-in modules for color management, image processing, threshold arrays, and/or device profiles, see FIG. 3A. This is a particularly powerful capability, making the printer driver an open source print driver. The driver is dynamically re-configurable because an application can provide plug-in modules that replace the default modules initially configured with the driver on a document-by-document, or a page-by-page basis.

To take full advantage of the open source feature, complementary enhancements to communicating applications are helpful. However, even without such complementary enhancements, the driver's capabilities are enhanced because changes can be made to the driver after installation at a customer site. These changes can be specific to the customer, for example, permitting the customer to customize the driver to their printing requirements.

Furthermore, improvements to the driver, by either the driver manufacturer or the customer, can be made after the driver is installed, without requiring a new installation at customers' sites. Conventionally, print drivers are written to allow the field replacement of device profiles without having to recompile and re-install the driver. However, as new algorithms for image processing or color management become available, there is no provision for field upgrading already installed drivers. This invention permits printer drivers to be field-upgraded with newer algorithms.

For example, a graphics company can install the standard driver, then customize it for its particular requirements by adding the appropriate threshold arrays, device profiles, and image processing plug-ins. These plug-ins can trade-off improved image quality against time-to-print for example.

Similarly, a text processing company may choose customized modules while still maintaining the core driver. In this manner, the driver manufacturer's maintenance responsibility covers a single version of the core, although there may be several variations of the driver at customers' sites.

In another variation, the print jobs may include both application specified print options and plug-ins, see FIG. 3B.

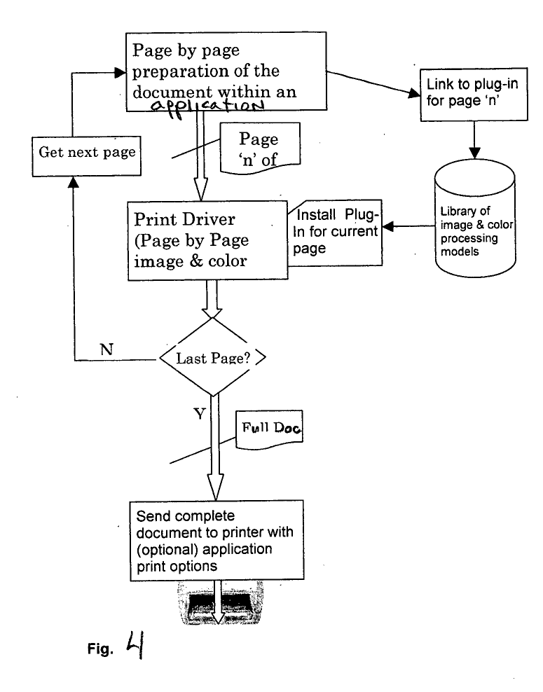

FIG. 4 is a diagram illustrating a page selection plug-in aspect of the printer driver. That is, plug-ins can be included dynamically for each page, or even each object on a page.

The printer drivers and their associated user interfaces (GUIs), permit user choices that have never before been available. A complete and fully detailed description of the printer driver is dependent upon the operating system context in which the print driver executes, as would be understood by one skilled in the art.

In addition to conventional communication protocols, proprietary transfer protocols and proprietary interfaces can be used that permit an application to replace one, or more, of the image and color processing modules that are included with the original installation of the print driver. Processing modules supplied by the application, or customized for the installation, can be transmitted to the driver as part of the setup for printing the document, see FIGS. 2 and 4. The proprietary transfer protocol permits the print driver to differentiate between the downloading of the processing modules and the document to be printed.

The following exemplifies the particular image and color processing that is dynamically alterable within any implementation:

1. For image processing, the principle computational modules can analyze the document for different types of content, i.e., photo, graphics, and text.

Different image understanding algorithms exist. Their variety suggests that a specific user chooses differently depending on the type of output needed. The choice of print media, inks used, fonts, image size, resolution, etc., all influence the choice of algorithms. Threshold arrays vary depending on print intent. When processing a single page, the image processing can use different algorithms to process the photo, text, and graphics.

API's permit the user to access and/or replace different image processing algorithms for each type of object, dynamically.

2. Similarly, for color management, image understanding, tone control, threshold arrays, device color profiles, color space transforms may all vary depending on the image and the output requirements. APIs covering each of these areas can be provided.

The driver can be delivered with a set of image and color processing default modules. These can be replaced at each customer site to conform to the site's requirements.

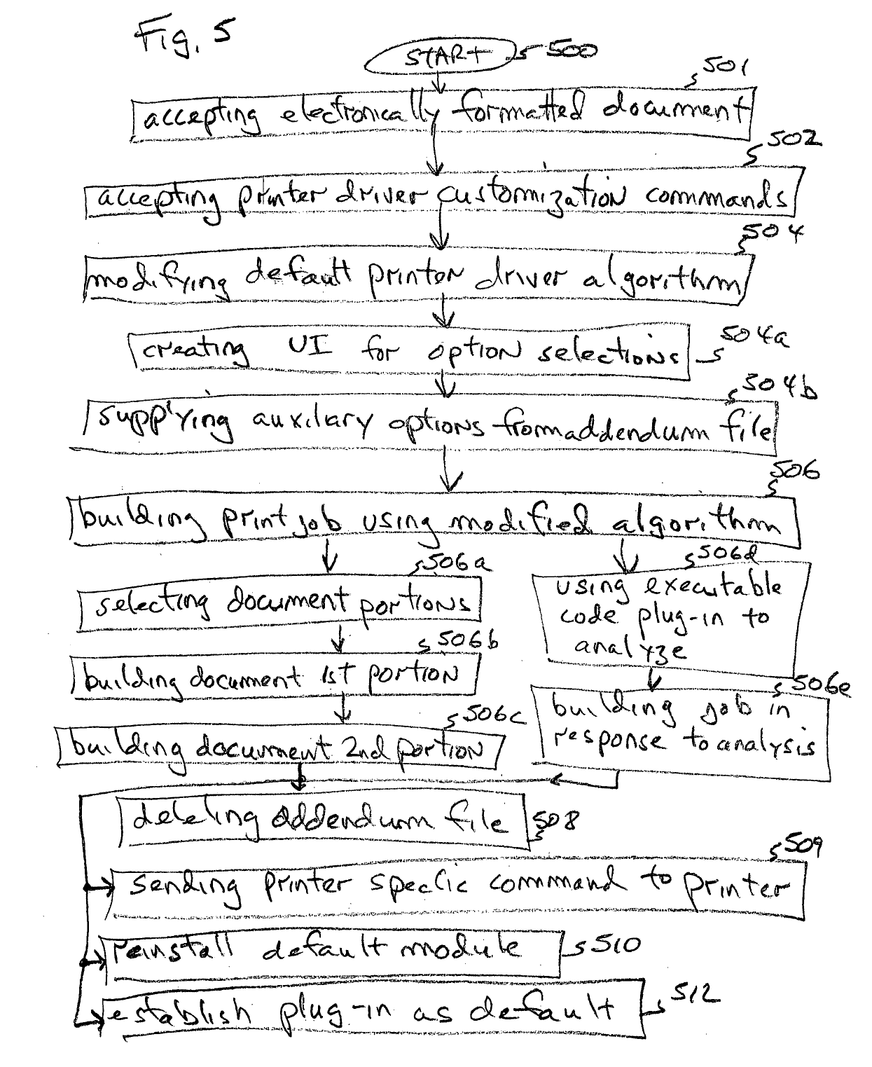

FIG. 5 is a flowchart illustrating an open source printer driver method. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 500.

Step 502 accepts a printer driver customization command. Step 504 modifies a default printer driver algorithm in response to the customization command. Step 506 builds a print job in a printer-ready format using the modified printer driver algorithm. For example, Step 506 may build the print job in a format such as PDL or PJL.

In one aspect, Step 501 accepts an electronically formatted document, and accepting a printer driver customization command in Step 502 includes accepting an addendum file attached to the document. For example, Step 501 may accept an electronically formatted document from an application such as MSWord, MSExcel, MSPowerPoint, MSPaint, web applications that display on monitors, digital image processing applications such as, Adobe Photoshop, ImageReady, Adobe Illustrator, or FrameMaker.

Modifying a printer driver algorithm in response to the customization command in Step 504 includes substeps. Step 504a creates a user interface (UI) for the selection of print options. Step 504b supplies auxiliary print options from the addendum file. For example, the addendum file auxiliary print options may include booklet, pamphlet, n-up, margin selections, media type, number of copies, output size, or overlay options. Then, building a print job in a printer-ready format using the modified printer driver algorithm in Step 506 includes building the print job using the auxiliary print options.

For example, building the print job using the auxiliary print options in Step 506 may include substeps. Step 506a selects first and second portions of the document. Step 506b uses the auxiliary print options to build the document first portion. Step 506c uses default print options to build the document second portion.

In one aspect an additional step, Step 508, deletes the addendum file after the print job is built. In another aspect, accepting an addendum file attached to the document in Step 502 includes accepting a printer-specific command file with the addendum file. Then, Step 509 sends the print job, with the printer-specific command file, to a printer.

In a different aspect of the method, accepting a printer driver customization command in Step 502 includes using an application programming interface (API) to accept an executable code plug-in module. Then, modifying a printer driver algorithm in response to the customization command (Step 504) includes replacing a printer driver executable code default module with the executable code plug-in module.

If an electronically formatted document is accepted in Step 501, then building a print job in a printer-ready format using the modified printer driver algorithm in Step 506 may include alternate substeps. Step 506d uses the executable code plug-in module to analyze document content, and Step 506e builds the print job in response to the analysis.

Using the executable code plug-in module to analyze document content in Step 506d may include analyzing content selected from the group including photo, graphics, and text content. Building the print job in response to the analysis (Step 506e) may include choosing image processing elements such as threshold arrays, device profiles, image processing plug-ins, media, inks, fonts, image size, or resolution.

For example, building a print job in a printer-ready format using the modified printer driver algorithm includes selecting first and second portions of the document in Step 506a. Step 506b builds a first portion of the print job using the executable code plug-in module to analyze the content of the document first portion. Step 506c builds a second portion of the print job using the executable code default module to analyze the content of the document second portion.

In one aspect, Step 510 reinstalls the executable code default module after the print job is built. In another aspect, Step 512 establishes the executable code plug-in module as the new printer driver executable code default module.

An open source, dynamically configurable, printer driver has been presented. Examples have been given of possible data, executable algorithms, and print options to help illustrate the invention. However, the invention is not limited to just these examples. Although the open source driver has been presented in the context of a printer driver, the invention has wider application to a broader class of image and text processing drivers. Other variations and embodiments of the invention will occur to those skilled in the art.

We claim:

1. An open source printer driver method, the method comprising:
accepting a printer driver customization command;
modifying a default printer driver algorithm in response to the customization command; and,
building a print job in a printer-ready format using the modified printer driver algorithm.

2. The method of claim 1 further comprising:
accepting an electronically formatted document;
wherein accepting a printer driver customization command includes accepting an addendum file attached to the document;
wherein modifying a printer driver algorithm in response to the customization command includes:
creating a user interface (UI) for the selection of print options; and,
supplying auxiliary print options from the addendum file; and,
wherein building a print job in a printer-ready format using the modified printer &river algorithm includes building the print job using the auxiliary print options.

3. The method of claim 2 wherein building the print job using the auxiliary print options includes:
selecting first and second portions of the document;
using the auxiliary print options to build the document first portion; and,
using default print options to build the document second portion.

4. The method of claim 2 further comprising:
deleting the addendum file after the print job is built.

5. The method of claim 2 wherein accepting an addendum file attached to an electronically formatted document includes accepting an addendum file with auxiliary print options selected from the group including booklet, pamphlet, n-up, margin selections, media type, number of copies, output size, and overlay.

6. The method of claim 1 wherein accepting a printer driver customization command includes using an application programming interface (API) to accept an executable code plug-in module; and,
wherein modifying a printer driver algorithm in response to the customization command includes replacing a printer driver executable code default module with the executable code plug-in module.

7. The method of claim 6 further comprising:
accepting an electronically formatted document;
wherein building a print job in a printer-ready format using the modified printer driver algorithm includes:
using the executable code plug-in module to analyze document content; and,
building the print job in response to the analysis.

8. The method of claim 7 wherein using the executable code plug-in module to analyze document content includes analyzing content selected from the group including photo, graphics, and text content.

9. The method of claim 7 wherein building the print job in response to the analysis includes choosing image processing elements selected from the group including threshold arrays, device profiles, image processing plug-ins, media, inks, fonts, image size, and resolution.

10. The method of claim 7 further comprising:
reinstalling the executable code default module after the print job is built.

11. The method of claim 7 wherein building a print job in a printer-ready format using the modified printer driver algorithm includes:
selecting first and second portions of the document;
building a first portion of the print job using the executable code plug-in module to analyze the content of the document first portion; and,
building a second portion of the print job using the executable code default module to analyze the content of the document second portion.

12. The method of claim 2 wherein accepting an addendum file attached to the document includes accepting a printer-specific command file with the addendum file; and,
sending the print job, with the printer-specific command file, to a printer.

13. The method of claim 2 wherein accepting an electronically formatted document includes accepting a document from an application selected from the group including MSWord, MSExcel, MSPowerPoint, MSPaint, web applications that display on monitors, digital image processing applications such as, Adobe Photoshop, ImageReady, Adobe Illustrator, and FrameMaker.

14. The method of claim 1 wherein building the print job in a printer-ready format includes building the print job in a format selected from the group including a page description language (PDL) and printer job language (PJL).

15. The method of claim 6 further comprising:
establishing the executable code plug-in module as the new printer driver executable code default module.

16. An open source printer driver system, the system comprising:
a source control module having an interface to accept a printer driver customization command and an interface to supply a modified printer driver algorithm in response to the customization command; and,
a format module having an interface connected to the source control module and a printer interface supplying a print job in a printer-ready format using the modified printer driver algorithm.

17. The system of claim 16 further comprising:
a user interface (UI) module to supply print options and accept print option selections;
wherein the format module has an interface to accept an electronically formatted document;
wherein the source control module accepts an addendum file customization command attached to the document, supplies auxiliary print options to the UI module from the addendum file, and relays auxiliary print option selections from the UI module, to the format module; and,
wherein the format module builds the print job using the auxiliary print option selections.

18. The system of claim 17 further comprising:
a default module having an interface connected to the source control module to supply default print options;
wherein UI supplies default and auxiliary print options and accepts default and auxiliary print option selections;
wherein the source control module relays selected auxiliary and default print options to the format module; and,
wherein the format module builds a first portion of the document using the auxiliary print option selections and builds a second portion of the document using the default print option selections.

19. The system of claim 17 wherein the source control module deletes the addendum file after the print job is built.

20. The system of claim 17 wherein the source control module accepts an addendum file with auxiliary print options selected from the group including booklet, pamphlet, n-up, margin selections, media type, number of copies, output size, and overlay.

21. The system of claim 16 wherein the source control module uses an application programming interface (API) to accept an executable code plug-in module and supplies executable code from the plug-in module to the format module; and,
wherein the format module has an interface to accept data, the format module processing the data using the executable code from the plug-in module and building the print job using the processed data.

22. The system of claim 21 wherein the format module has an interface to accept an electronically formatted document, uses the executable code from the plug-in module to analyze document content, and builds the print job in response to the analysis.

23. The system of claim 22 wherein the format module analyzes document content selected from the group including photo, graphics, and text content.

24. The system of claim 22 wherein the format module analyzes document content and chooses image processing elements selected from the group including threshold arrays, device profiles, image processing plug-ins, media, inks, fonts, image size, and resolution.

25. The system of claim 22 wherein the source control module erases the executable code plug-in module after the print job is built.

26. The system of claim 22 further comprising:
at least one executable code default module having an interface connected to the source control module to supply default executable code;
wherein the format module builds the first portion of the print job using the executable code from the plug-in module to analyze the content of a document first portion, and builds a second portion of the print job using the executable code from the default module.

27. The system of claim 17 wherein the source control module accepts a printer-specific command file with the addendum file and relays the printer-specific command file to the format module; and,
wherein the format module sends the print job, with the printer-specific command file, to a printer.

28. The system of claim 17 wherein the format module accepts an electronically formatted document from an application selected from the group including MSWord, MSExcel, MSPowerPoint, MSPaint, web applications that display on monitors, digital image processing applications such as, Adobe Photoshop, ImageReady, Adobe Illustrator, and FrameMaker.

29. The system of claim 16 wherein the format module formats the print job in a format selected from the group including a page description language (PDL) and printer job language (PJL).

30. The system of claim 21 wherein the executable code plug-in module is established to supply default executable code to the source control module.
